(19) United States
(12) Patent Application Publication
(10) Pub. No.: US 2021/0383217 A1
(43) Pub. Date: Dec. 9, 2021

(54) METHOD FOR PROVIDING COMPANION ANIMAL SOUND SERVICE WITH ARTIFICIAL INTELLIGENCE BASED ON DEEP NEURAL NETWORK MACHINE LEARNING

(71) Applicants: Sung Ki LIM, Seoul (KR); Myung Ki LIM, Seoul (KR)

(72) Inventors: Sung Ki LIM, Seoul (KR); Myung Ki LIM, Seoul (KR)

(21) Appl. No.: 17/281,911

(22) PCT Filed: Sep. 27, 2019
(86) PCT No.: PCT/KR2019/012653

§ 371 Date: Mar. 31, 2021

(30) Foreign Application Priority Data
Oct. 4, 2018 (KR) 10-2018-0118401
Jan. 23, 2019 (KR) 10-2019-0008639

(51) Int. Cl. G06N 3/08; G06K 9/00

(52) U.S. Cl. CPC G06N 3/08; G06K 9/00369

(57) ABSTRACT

Disclosed is a method for providing a companion animal sound service by using artificial intelligence based on deep neural network machine learning, comprising: requesting, by a management server, recording and uploading of sounds for each intention or emotion of a user's companion animal to a companion animal application executed in a user terminal; uploading, by the companion animal application, data of the requested and recorded sounds for each intention or emotion of the user's companion animal to the management server; training, by the management server, an artificial intelligence model based on deep neural network machine learning with the uploaded data of the sounds for each intention or emotion; providing, by the management server, the trained artificial intelligence model to the companion animal application; and generating, by the companion animal application, sounds for the companion animal corresponding to a user input and outputting the sounds via a speaker.

### CROSS-REFERENCE TO RELATED APPLICATIONS

This application claims the priority of Korean Patent Applications No. 10-2018-0118401 filed on Oct. 4, 2018, and No. 10-2019-0008639 filed on Jan. 23, 2019, in the Korean Intellectual Property Office, the disclosure of which is incorporated herein by reference.

### BACKGROUND OF THE INVENTION

### Field of the Invention

The present invention relates to a technology for communication with companion animals.

### Description of the Related Art

As research on artificial intelligence based on deep neural network machine learning is actively progressing, systems and methods for synthesizing human voice using artificial intelligence based on deep neural network machine learning are emerging. Unlike conventional human speech synthesis systems and methods, human voice synthesis systems and methods using artificial intelligence based on deep neural network machine learning train large-scale human voice data on a deep neural network artificial intelligence model implemented on a high-performance computer system and then synthesize and reproduce high-quality human voice using the trained deep neural network artificial intelligence model. When such an artificial intelligence model based on deep neural network machine learning is compared with conventional methods of synthesizing and reproducing human voice using a complex human voice synthesis model, it is possible to provide a stable voice synthesis system capable of synthesizing and reproducing high-quality human voice without using a complex voice synthesis model.

However, conventional systems and methods for synthesizing animal sounds representing the intentions of animals record and collect all animal sounds representing the intentions of the animals and then combine pieces of the corresponding animal sounds in order to express a desired intention to synthesize and reproduce the animal sounds. Alternatively, there are used systems and methods of synthesizing and reproducing the animal sounds by recording and collecting all animal sounds representing the intention or emotion of the animal, decomposing and storing the animal sounds into frequencies or specific elements, and then combining the frequencies or specific elements of the animal sounds corresponding to the desired intention or emotion of the animal. Such conventional systems and methods are too difficult to collect and gather animal sounds indicating the intention or the emotion of the animals. In addition, there are problems in that it is difficult to synthesize high-quality animal sounds that accurately represent the intention of animals, or that systems and methods are too complex to be used, are very expensive, or are susceptible to errors.

The above-described technical configuration is the background art for assisting the understanding of the present invention, and does not mean a conventional technology widely known in the art to which the present invention belongs.

### SUMMARY OF THE INVENTION

An object of the present invention is to provide a method for easily reproducing an expression that a user wants to communicate with a companion animal as a companion animal sound.

According to an aspect of the present invention, a method for providing a companion animal sound service using an artificial intelligence model based on deep neural network machine learning, the method may include the steps of: requesting, by a management server, recording and uploading of sounds for each intention or emotion of a user's companion animal to a companion animal application executed in a user terminal; uploading, by the companion animal application, data of the requested and recorded sounds for each intention or emotion of the user's companion animal to the management server; combining and classifying, by the management server, the uploaded sound data for each intention or emotion of the user's companion animal together with characters expressing the intention or emotion and sounds of the companion animal corresponding to the characters to refine and process the sound data as training data for training the artificial intelligence model based on deep neural network machine learning; combining and classifying, by the management server, the sound data for each intention or emotion of the companion animal together by analyzing/extracting pitches of the sounds, duration of the sounds, the repetition number of the sounds, etc. in addition to characters expressing the intention or emotion to refine and process the sound data as training data for training the artificial intelligence model based on deep neural network machine learning, when refining and processing the training data; training, by the management server, the artificial intelligence model based on deep neural network machine learning as the training data consisting of the sounds for each intention or emotion, the characters expressing the intention or emotion, the pitches of the sounds, the duration of the sounds, the repetition number of the sounds, etc. which are combined, refined, and processed; providing, by the management server, the trained artificial intelligence model to the companion animal application; generating, by the companion animal application, sounds for the companion animal corresponding to a user input by using the artificial intelligence model, and outputting the sounds via a speaker; and generating, by the artificial intelligence model, sounds of the companion animal corresponding to the intention or emotion of the companion animal expressed by the user input together with the pitches of the sounds corresponding to the intention or emotion of the companion animal, the duration of the sounds, the repetition number of the sounds, etc. and outputting the generated sounds via a speaker.

The requesting of the recoding and uploading of the sounds may be to request the recording and uploading of the sounds expressing some intentions or emotions among all intentions or emotions which are expressed by the sounds of the user's companion animal.

The method for providing the companion animal sound service may further include checking, by the management server, a breed of the user's companion animal, wherein the requesting of the recoding and uploading of the sounds may be to request the recording and uploading of the sounds expressing some intentions or emotions corresponding to the checked breed.

The checking of the breed may include requesting images of the user's companion animal to the companion animal application; and analyzing the image of the user's companion animal received from the companion animal application for checking the breed.

The method for providing the companion animal sound service may further include selecting, by the management server, an artificial intelligence model which has been pre-trained using pre-training data for the breed of the user's companion animal from a plurality of artificial intelligence models, wherein the training may be to train the selected artificial intelligence model with the uploaded sound data for each intention or emotion.

According to the present invention, it is possible to easily reproduce intentions or emotions that a user wants to communicate with a companion animal into sounds to be understood by the companion animal by using artificial intelligence based on deep neural network machine learning.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram of a system for providing a companion animal sound service according to an embodiment;

FIG. 2 is a block diagram of a system for refining and processing training data for training an artificial intelligence model for a user companion animal according to an embodiment;

FIG. 3 is a block diagram of a system for generating sounds of a companion animal through an inference system including an artificial intelligence model that has been trained after training an artificial intelligence model for a user companion animal using training data according to an embodiment;

FIG. 4 is a flowchart illustrating a process of providing an artificial intelligence model for a user's companion animal according to an embodiment;

FIG. 5 is a flowchart illustrating a process of reproducing a user's companion animal sounds according to an embodiment; and

FIG. 6 is a flowchart illustrating a process of reproducing a user's companion animal sounds according to another embodiment.

### DETAILED DESCRIPTION OF THE PREFERRED EMBODIMENT

The foregoing and additional aspects of the present invention will become more apparent through preferred embodiments described with reference to the accompanying drawings. Hereinafter, the present invention will be described in detail so that those skilled in the art can easily understand and reproduce the present invention through these embodiments.

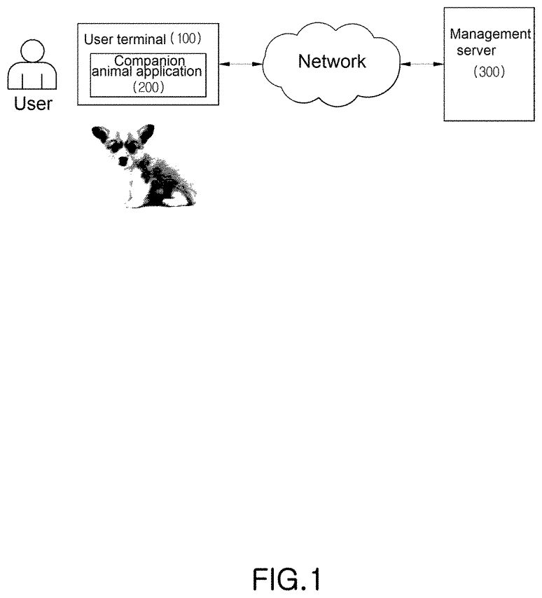

FIG. 1 is a block diagram of a communication system customized for a user's companion animal according to an embodiment. As illustrated in FIG. 1, the communication system customized for a user's companion animal may include a user terminal 100 and a management server 300. Alternatively, the communication system customized for the user's companion animal may mean only the management server 300, and may also include a companion animal communication application 200 (hereinafter referred to as a ‘companion animal application’) installed and executed on the management server 300 and the user terminal 100. In addition, the user terminal 100 and the management server 300 may perform data communication through a network. The network may include a plurality of heterogeneous networks, and may support a plurality of communication protocols. For example, the network supports at least some of the communication protocols such as TCP/IP, IPX, SPX, NetBIOS, Ethernet, ARCNET, Fiber Distributed Data Interface (FDDI), IEEE 802.11, IEEE 802.11a, and direct synchronization connection. The user terminal 100 and the management server 300 may perform data communication through such a network.

The user terminal 100 is a communication terminal having a computing function and may be a mobile terminal such as a smartphone. The user terminal 100 includes the companion animal application 200. The companion animal app 200 provides a service that enables communication between the user and the user's companion animal. The management server 300 includes a web server, a web application server (WAS), a database server, a deep neural network machine learning training server, a deep neural network machine learning inference server, etc. The management server 300 may be operated under a variety of operating systems, including or not included in a Windows-based operating system, MacOS, Java, UNIX, or LINUX. The management server 300 interworks with the companion animal application 200 to provide a service and an artificial intelligence model for communication with the companion animal to the user.

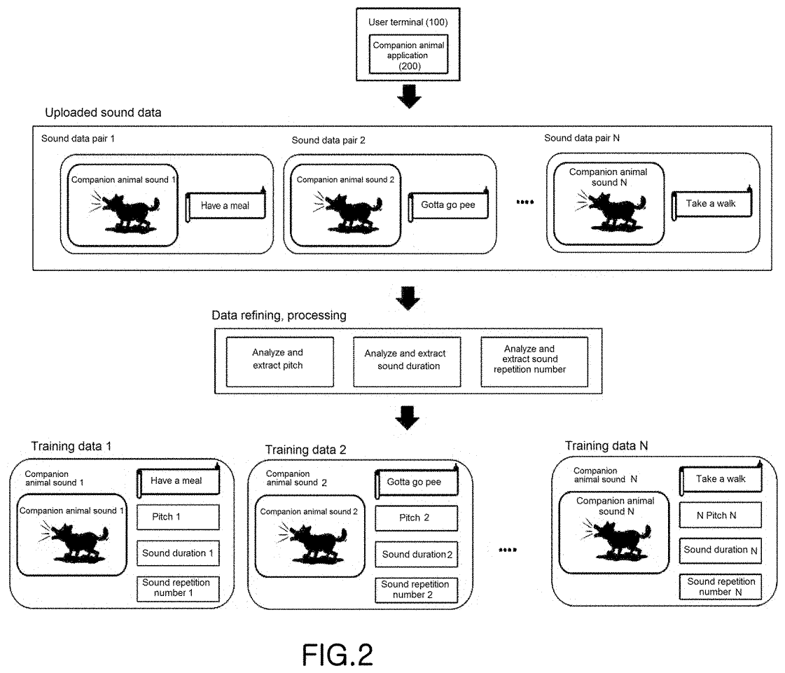

FIG. 2 is a block diagram of a system for refining and processing training data for training an artificial intelligence model for a user companion animal according to an embodiment. As illustrated in FIG. 2, the sounds data of the user's companion animal uploaded to the management server 300 according to the intention or emotion is combined and classified with characters expressing the intention or emotion and the sounds of the companion animal corresponding to the characters to be refined and processed into training data for training the artificial intelligence model based on the neural network machine learning. When the management server 300 refines and processes the training data, the management server 300 may combine and classify the sounds data for each intention or emotion of the companion animal together with pitches of the sounds, the duration of the sounds, the number of repetitions of sound, etc., in addition to characters expressing the intention or emotion to refine and process the sounds data as training data for training the artificial intelligence model based on the neural network machine learning.

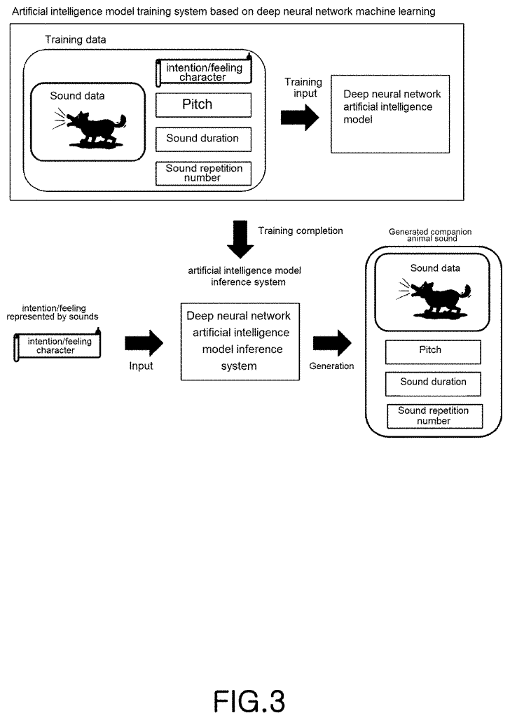

FIG. 3 is a block diagram of a system for generating sounds of a companion animal through an inference system including an artificial intelligence model that has been trained after training an artificial intelligence model for a user companion animal using training data according to an embodiment. As illustrated in FIG. 3, the refined and processed training data are input to the artificial intelligence model based on deep neural network machine learning to perform training. At this time, the training data may consist of sounds of the companion animal and intention/emotion characters corresponding to the sounds, pitches of the sounds, the duration of the sounds, the number of repetitions of the sound, and the like. When the training is completed, the inference system including the artificial intelligence model is configured, and when the user inputs the intention/emotion characters to be expressed, the companion animal sounds is generated by the inference system of the artificial intelligence model based on deep neural network machine learning. At this time, the inference system may generate sounds corresponding to the intention/emotion characters to be expressed, pitches of the sounds, the duration of the sounds, the number of repetitions of the sound, and the like.

Furthermore, such an artificial intelligence model inference system may use a generative adversarial networks (GAN) model. This GAN model is for generating elaborate new data through a pair of a generator and a classifier, and may generate new data having similar characteristics by training information about the sounds of the companion animal. Therefore, when this GAN model is applied, it is possible to determine the unique characteristics of companion animal sounds even within the training content classification divided into sounds and pitches, the duration of the sounds, repetition of the sounds, and intention/emotion characters corresponding thereto and to generate sounds of the companion animal similar to real sounds through the GAN model. For example, by training various types of companion animal sounds corresponding to “take a walk”, sounds to be actually provided may be generated similar to the sounds of the user's companion animal or transformed and generated according to a criteria specified by the user. Even when training about the companion animal is not completed or there is little training content, the companion animal sounds that has not been trained or has little training content may be generated based on contents trained through other companion animals.

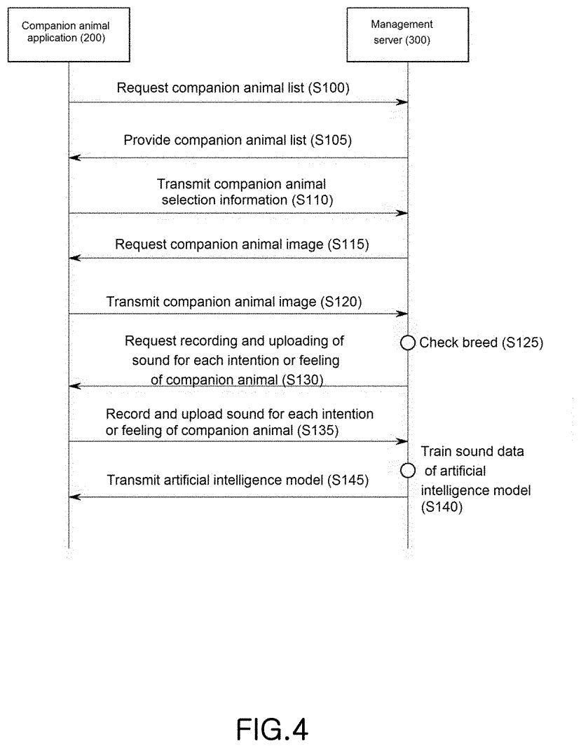

FIGS. 4 to 6 are flowcharts illustrating a method for providing a companion animal sound service using artificial intelligence based on deep neural network machine learning. First, FIG. 4 will be described. FIG. 4 is a flowchart illustrating a process of providing an artificial intelligence model for a user companion animal according to an embodiment. The companion animal application 200 is executed by a user operation and requests a companion animal list to the management server 300 according to a user command (S100), and the management server 300 provides the companion animal list to the companion animal application 200 (S105). The companion animal list includes items such as dogs and cats. The companion animal application 200 receives the companion animal list and displays the received companion animal list on a screen so that the user may select a user's companion animal type. As another example, the companion animal application 200 has a companion animal list in advance and displays the companion animal list on the screen without the need to be requested to the management server 300.

The user selects a companion animal item from the companion animal list, and if the user's companion animal is a dog, the user selects a dog from the companion animal list. When the companion animal item is selected from the companion animal list, the companion animal application 200 transmits companion animal selection information to the management server 300 (S110). When the selected companion animal is checked, the management server 300 requests an image of the user's companion animal to the companion animal application 200 (S115). Accordingly, the companion animal application 200 notifies the user that there is a request for the companion animal image, and the user photographs the user's companion animal or selects a pre-stored user's companion animal image. The companion animal app 200 transmits the photographed or selected companion animal image to the management server 300, and the management server 300 analyzes the transmitted companion animal image to check the breed of the user's companion animal. For reference, the breed of the dog includes poodle, Jindo dog, Maltese, Shichu, Yorkshire terrier, Chihuahua, Pemoranian, Sapsal dog, Siberian husky, and the like, and the management server 300 checks which breed of the dog is through analysis of the companion animal image. As another example, the management server 300 may allow the breed to be selected while presenting a breed list to the companion animal application 200, and the breed list may be reflected in the companion animal list and presented together.

The management server 300 requests recording and uploading of sounds for each intention or emotion of the user's companion animal to the companion animal application 200 (S130). In this case, the management server 300 does not request recording and uploading of all of sounds of intentions or emotions that may be expressed by the companion animal, but requests recording and uploading of some of the sounds of intentions or emotions. Accordingly, the companion animal application 200 records and uploads the sounds of the user's companion animal according to some intentions or emotions. Here, some intentions/emotions may be varied for each companion animal, and also varied for each breed of the companion animal. It will be considered that the characteristics of each companion animal and for each breed even in the same type of companion animal are varied and thus, intentions or emotions to be mainly expressed are varied.

In one embodiment, information on some intentions/emotions for each companion animal or breed is stored in a database, and the management server 300 searches the information on some intentions/emotions mapped to the user companion animal or the breed of the user companion animal from the database, and requests recording and uploading of the sounds of the user companion animal to the companion animal application 200 while transmitting the information to the companion animal application 200. If the user who confirms the request checks intention/emotion items belonging to the information on the intentions/emotions transmitted from the management server 300 and determines that the user's companion animal makes sounds corresponding to the checked intention/emotion item, the user operates the companion animal application 200 to command sounds recording and uploading, and the companion animal application 200 records the sounds of the companion animal for the corresponding item according to the command, and then uploads the recorded sounds data (S135). In this way, the sounds of the companion animal may be recorded and uploaded for all items belonging to the information on some intentions/emotions. In addition, the number of items belonging to the information on some intentions/emotions may be a predetermined number or less. For example, the information on some intentions/emotions consists of the items such as “I'm hungry”, “gotta go pee”, and “take a walk”.

When all the sounds data for the information on the intention/emotion requested by the companion animal application 200 are uploaded, the management server 300 processes and refines all of the uploaded sounds data as data to be trained by the artificial intelligence model based on deep neural network machine learning and then trains the artificial intelligence model with the training data (S140). When the management server 300 refines and processes the sounds data to generate the training data, the management server 300 may combine and classify the sounds data for each intention or emotion of the companion animal together with pitches of the sounds, the duration of the sounds, the number of repetitions of sound, etc., in addition to characters expressing the intention or emotion to refine and process the sounds data as training data for training the artificial intelligence model based on the neural network machine learning.

In an embodiment, the management server 300 selects an artificial intelligence model corresponding to a user companion animal or a breed of the user companion animal among artificial intelligence models that have been trained by using a sufficiently large amount of training data (pre-training data) in advance. The management server 300 further trains the selected artificial intelligence model as the refined and processed training data after being uploaded from the companion animal application 200. When the training is completed, the management server 300 transmits the artificial intelligence model to the companion animal application 200 (S145).

Some of the procedures of FIG. 4 above may be omitted. For example, at least some of S100 to S125 may be omitted. In addition, the order of the steps may also be reversed. Meanwhile, in processing and refining sounds data, the recorded sounds may be processed and refined for training, validation, and testing at an appropriate ratio. In addition, the processing and refining of the sounds data may be performed in the companion animal application 200 instead of the management server 300. That is, before uploading the recorded sounds data, the companion animal application 200 may process and refine the sounds data as data that can be trained by the artificial intelligence model based on deep neural network machine learning and then upload the sounds data.

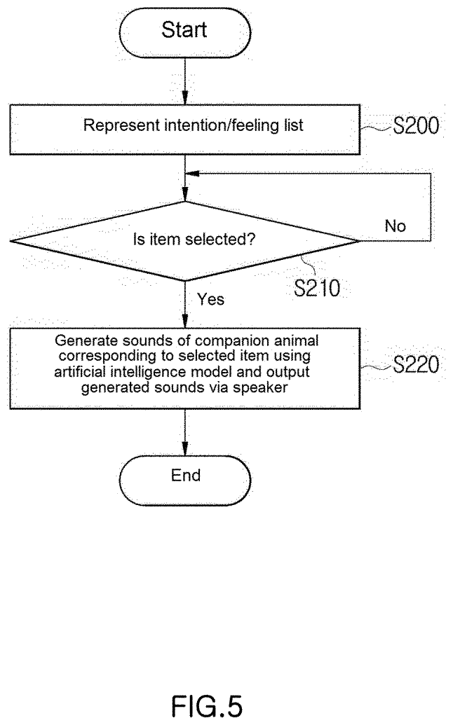

FIG. 5 is a flowchart illustrating a process of reproducing a user's companion animal sounds according to an embodiment. When the user operates the companion animal application 200 to express intentions or emotions to the companion animal, the companion animal application 200 presents an intention/emotion list that can be expressed to the companion animal. The intention/emotion list includes intention/emotion items such as “take a walk”, and “have a meal”. When the user selects any one item, the companion animal application 200 generates sounds of a companion animal corresponding to the selected item using the artificial intelligence model and then outputs the generated sounds via a speaker. Through this, what the user wants to express to the companion animal may be reproduced as sounds that the companion animal can recognize.

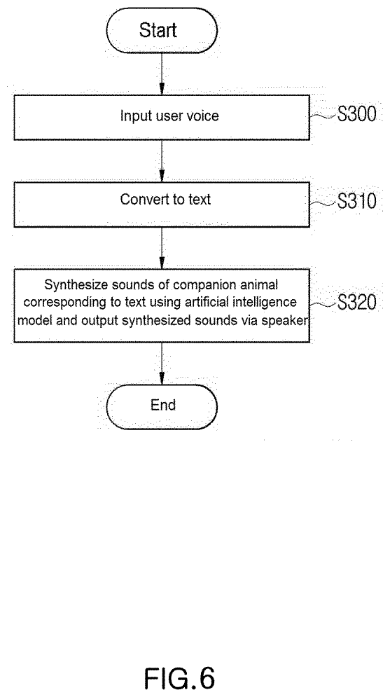

FIG. 6 is a flowchart illustrating a process of reproducing a user's companion animal sounds according to another embodiment. The companion animal application 200 receives a voice from the user (S300), analyzes the received voice, and converts the analyzed voice into a text (S310). The companion animal application 200 generates sounds of a companion animal corresponding to the text using an artificial intelligence model and then outputs the generated companion animal sounds via a speaker (S320). In one embodiment, the companion animal application 200 determines whether there is an item corresponding to the converted text among the intention/emotion items included in the intention/emotion list and generates the companion animal sounds corresponding to the corresponding item using the artificial intelligence model when there is a corresponding item as a determined result.

The present invention has been described above with reference to preferred embodiments thereof. It is understood to those skilled in the art that the present invention may be implemented as a modified form without departing from an essential characteristic of the present invention. Therefore, the disclosed embodiments should be considered in an illustrative viewpoint rather than a restrictive viewpoint. The scope of the present invention is defined by the appended claims rather than by the foregoing description, and all differences within the scope of equivalents thereof should be construed as being included in the present invention.

1. A method for providing a companion animal sound service using an artificial intelligence model based on deep neural network machine learning, the method comprising the steps of:
requesting, by a management server, recording and uploading of sounds for each intention or emotion of a user's companion animal to a companion animal application executed in a user terminal;
uploading, by the companion animal application, data of the requested and recorded sounds for each intention or emotion of the user's companion animal to the management server;
training, by the management server, an artificial intelligence model based on deep neural network machine learning with the uploaded data of the sounds for each intention or emotion;
providing, by the management server, the trained artificial intelligence model to the companion animal application; and
generating, by the companion animal application, sounds for the companion animal corresponding to a user input by using the artificial intelligence model, and outputting the sounds via a speaker.

2. The method of claim 1, wherein the requesting of the recoding and uploading of the sounds is to request the recording and uploading of the sounds expressing some intentions or emotions among all intentions or emotions which are expressed by the sounds of the user's companion animal.

3. The method of claim 2, further comprising:
checking, by the management server, a breed of the user's companion animal,
wherein the requesting of the recoding and uploading of the sounds is to request the recording and uploading of the sounds expressing some intentions or emotions corresponding to the checked breed.

4. The method of claim 3, wherein the checking of the breed comprises
requesting images of the user's companion animal to the companion animal application; and
analyzing the image of the user's companion animal received from the companion animal application for checking the breed.

5. The method of claim 3, further comprising:
selecting, by the management server, an artificial intelligence model which has been pre-trained using pre-training data for the breed of the user's companion animal from a plurality of artificial intelligence models,
wherein the training is to train the selected artificial intelligence model with the uploaded sound data for each intention or emotion.

6. The method of claim 1, further comprising:
combining and classifying, by the management server, the uploaded sound data for each intention or emotion of the user's companion animal together with characters expressing the intention or emotion and sounds of the companion animal corresponding to the characters to refine and process the sound data as training data for training the artificial intelligence model based on deep neural network machine learning,
wherein the refining and processing as the training data is to combine and classify the sound data for each intention or emotion of the companion animal together with pitches of the sounds, the duration of the sounds, the repetition number of the sounds, etc. in addition to the characters expressing the intention or emotion, refine and process the combined and classified sound data as the training data, and train the artificial intelligence model.

7. The method of claim 6, further comprising:
generating, by the management server, companion animal sounds corresponding to the intention/emotion characters to be expressed by an inference system of the artificial intelligence model based on deep neural network machine learning together with pitches of the companion animal sounds, the duration of the companion animal sounds, the repetition number of the companion animal sounds, etc., when the user inputs intention/emotion characters to be expressed through the inference system including the trained artificial intelligence model.

8. The method of claim 4, further comprising:
selecting, by the management server, an artificial intelligence model which has been pre-trained using pre-training data for the breed of the user's companion animal from a plurality of artificial intelligence models,
wherein the training is to train the selected artificial intelligence model with the uploaded sound data for each intention or emotion.
